(19) United States
(12) Patent Application Publication
(10) Pub. No.: US 2001/0046574 A1
(43) Pub. Date: Nov. 29, 2001

(54) Barrier laminate with a polymeric nanocomposite oxygen barrier layer for liquid packaging

(76) Inventor: James F. Curtis, Clyde, NC (US)

Correspondence Address: DORITY & MANNING, P.A., POST OFFICE BOX 1449, GREENVILLE, SC, 29602-1449, US

(21) Appl. No.: 09/833,521

(22) Filed: Apr. 12, 2001

Related U.S. Application Data
(63) Continuation of application No. 09/144,212, filed on Aug. 31, 1998, now abandoned.

(51) Int. Cl. B32B 1/02

(52) U.S. Cl. 428/34.2

(57) ABSTRACT

The present invention relates to an improved laminate for containers of liquid, such as juice, the laminate comprising: a paperboard substrate; an outer layer of a member selected from the group consisting of heat-sealable low density polyethylene polymers and Plexar; and an inner barrier layer of a polymeric nanocomposite blend comprising at least one resin and a layered silicate dispersed in said resin. The layered silicate preferably has a layer thickness of about 7 to 12 A and an interlayer thickness of about 30 A or greater.

### BACKGROUND OF THE INVENTION

This invention relates to barrier laminates for use in packaging liquids, such as juice, the cartons or containers made from those barrier laminates, as well as to a method of making such laminates. More particularly the invention relates to a paperboard barrier laminate which makes use of an oxygen barrier layer formed from a polymeric nanocomposite in order to enhance the barrier properties of the laminate.

Glass containers have been used for many years to store and transport juice and milk, but have a number of disadvantages including shipping costs for the empty containers, disposal problems, breakage and weight problems. Similarly, blow molded plastic containers for juices and milk are also available, but the empty containers are comparatively expensive to transport and do not prevent loss of vitamin C from a juice product contained in them. In addition manufacturing costs for such all-plastic containers can be prohibitive since expensive equipment is involved in their manufacture.

The advantages of comparatively low container weight, ease of sealing and opening, ease of disposal and low shipping volume for the empty containers (since the containers can be shipped in a collapsed condition), make containers based on a paperboard substrate the current favored choice for marketing juice products and milk. These cartons are known in the trade as “gable top”, containers or cartons.

For example, one such carton, or gable-top milk carton, is described in U.S. Pat. No. 3,120,333. Blanks used to make this carton include a paperboard base, which is extrusion coated with resin on both sides. The resin, which may be polyethylene, provides a moisture barrier and means for heat-sealing the carton. U.S. Pat. No. 4,806,399 also discloses a barrier layer comprising a low density polyethylene.

In a typical carton converting operation, once the resin-blanks are scored and cut, the resin on an outer surface of a glue flap and the resin on an inner surface of a carton panel are heated by direct flame application. The carton panels are then folded over to form a flattened tube, the now molten tacky resin on the heated surfaces are pressed together at a downstream nip to form a liquid-tight seam. The cartons, in a flattened tube form, can then be shipped to users such as juice manufacturers or dairies where they are erected, the bottoms heat sealed, filled and their tops finally sealed.

Although considerations of cost make paperboard containers desirable for containing fruit juices and milk, other factors are also important. These involve the choice of a suitable barrier (laminate) for carton construction for retention of flavor and vitamin content during storage. The effect of diffusion of oxygen into the liquid in the container through the barrier laminate and absorption of essential oils from the liquid into the laminate, remain important considerations in the choice of a suitable laminate.

Laminates containing a metal foil have been used to make a foldable paperboard-based carton for a juice product. These metal foil-containing containers do retain the vitamin content and flavors in the juice for a substantial period of time (around ten weeks), but are expensive compared to containers that do not require a metal foil in the laminate from which they are made. Further, metal foil laminates are prone to develop pin holes seriously affecting their ability to contain liquids. Thus, considerable effort has been devoted to finding the best layer structure in a barrier laminate.

A further advance in the art of making a juice or milk carton resulted from the introduction of a laminate, which also provided an effective barrier for oxygen and thus helped retain vitamin C in the juice stored in a carton made from it. This laminate, which is described in U.S. Pat. No. 4,777,088, comprises from the outer surface to the inner surface, an outer polyolefin coating that provides the heat seal bond, a paperboard substrate that provides the structure of the carton, a nylon layer coated directly on the paperboard substrate, a layer of modified polyethylene (Bynel E 388) directly overlying and in contact with the nylon layer and an inner polyolefin layer in contact with the modified polyethylene layer. Not only does the nylon barrier layer in this laminate help retain vitamin C, but also the laminate helps retain essential oils and flavors.

Other barrier laminates capable of excluding oxygen and preventing loss of oils and/or flavors are described in U.S. Pat. Nos. 4,701,360, 4,861,526 and 4,698,246 in which both sides of a paperboard substrate are first flame treated and a layer of low density polyethylene (LDPE) then applied to the outside surface. To the surface of the paperboard which becomes the inside surface of the carton, first, a layer of low density polyethylene is applied directly to the paperboard. Then a nylon barrier layer is applied to that interior low density polyethylene layer with a bonding tie layer between the nylon and polyethylene. Finally, an innermost skin layer is applied to the nylon with another tie layer to improve the adhesion of the layers and to help in heat sealing. A preferred skin layer is ethylene vinyl alcohol polymer. This process is comparatively complicated and involves a substantial number of layers. Other patents disclosing a laminate including a tie layer and an inner layer of polycarbonate polymer include U.S. Pat. No. 4,806,399.

Other existing commercial structures include heat-sealable barrier laminates providing a substantial barrier to the loss of Vitamin C and an almost complete barrier to the loss of essential flavor oils over the shelf life period of the carton (six weeks) and far beyond the six week period as well have been proposed. For example U.S. Pat. Nos. 4,701,360 and 4,950,510 teach barrier laminates including from the outer surface to the inner surface contacting the juice containing essential oils and/or flavors, an exterior layer of a low density polyethylene, a paperboard substrate, an interior layer of a low density polyethylene and a layer of ethylene vinyl alcohol copolymer (EVOH) coated onto the interior layer of low density polyethylene on the interior surface of the paperboard substrate, in contact with the juice rendering the laminate heat-sealable. Other patents disclosing a heat-sealable ethylene vinyl alcohol copolymer barrier layer include U.S. Pat. Nos. 4,789,575, Re. 33,376, 5,133,999, 5,175,036 and 4,977,004.

U.S. Pat. Nos. 4,990,562, 5,126,401 and 5,126,402 describe blends of ethylene vinyl alcohol copolymer with an amorphous polyamide component and their use as barrier layers in multilayer containers formed by deformation processes. Examples of deformation processes include thermoforming (excluding melt phase thermoforming), vacuum-forming, solid phase pressure forming, co-injection blow molding, co-injection stretch blow molding, tube extrusion followed by stretching, scrapless forming, forging, and tubular or flat sheet oriented film processes. Examples of articles that can be prepared using deformation processes are films and containers such as bottles, jars, cans, bowls, trays, dishes, pouches, oriented films, and shrink films.

It is an object of the present invention to provide a comparatively economical barrier laminate for juice and/or milk cartons of the above described kind, this barrier laminate having an oxygen barrier layer that protects from oxygen degradation of essential nutrient and vitamin components, particularly Vitamin C, and layer that prevents loss of essential oils and/or flavor.

According to the present invention, the preferred laminate providing an effective barrier to the intrusion of oxygen and migration of essential oils and/or flavorings and for the retention of Vitamin C, essential oils and flavor in fruit juices comprises from the outer surface to the inner surface contacting the juice or other liquid, a first exterior layer of a low density polyethylene polymer (“LDPE”), a paperboard substrate and an interior oxygen barrier layer formed from a polymeric nanocomposite. Preferably the polymeric nanocomposite is a polymeric blend comprising one or more resins having a layered silicate dispersal therein. The layered silicate preferably has a layer thickness of 7 to 12 A and an interlayer distance of about 20 A or above, and most preferable at least 30 A or above. Polymeric nanocomposites, and processes for preparing them are disclosed in U.S. Pat. Nos. 4,889,885, and 4,739,007 issued to Kabushiki Kaisha Toyota Chou Kenkyusho and the disclosures of these patents are hereby incorporated by reference herein.

In accordance with a second embodiment of the present invention the composite structure comprises from the outer surface to the inner surface contacting the juice or other liquid, a first exterior layer of a low density polyethylene polymer, a paperboard substrate, a layer of low density polyethylene polymer and an interior oxygen barrier layer formed from a polymeric nanocomposite as described above.

A third embodiment of the present invention comprises the addition of a layer of one of EVOH, polyethyleneterephthalate, polyethylene isophthalate, acid or glycol-modified copolymers of polyethyleneterephthalate and polyethyleneisophthalate, polyamides, polycaprolactans and polycarbonates as a skin layer.

Another embodiment substitutes for the first exterior layer of low density polyethylene an extrudable adhesive resin such as Plexar, a modified polyolefin or modified copolymer of an olefin such as ethylene or ethylene vinyl acetate.

In still another embodiment a tie layer acting as an adherent may be interposed between the paperboard and the blend or between the interior low density polyethylene layer and the polymeric nanocomposite oxygen barrier or between the polymeric nanocomposite oxygen barrier and the skin layer. Examples of suitable tie layer materials include Plexar, modified polyolefin or modified copolymers of an olefin such as ethylene or ethylene vinyl acetate.

### BRIEF DESCRIPTION OF THE DRAWINGS

The accompanying drawings illustrate several aspects of the present invention, and together with the description serve to explain the principles of the invention. In the drawings:

FIG. 1 is a cross-sectional elevation of an embodiment of the laminate of the invention;

FIG. 2 is a cross-sectional elevation of an alternate embodiment of the laminate of the present invention;

FIG. 3 is a cross-sectional elevation of an alternate embodiment of the laminate of the present invention;

FIG. 4 is a cross-sectional elevation of an alternate embodiment of the laminate of the present invention;

FIG. 5 is a cross-sectional elevation of an alternate embodiment of the laminate of the present invention;

FIG. 6 is a cross-sectional elevation of an alternate embodiment of the present invention;

FIG. 7 is a cross-sectional elevation of an alternate embodiment of the present invention; and

FIG. 8 is a cross-sectional elevation of an alternate embodiment of the present invention.

### DETAILED DESCRIPTION OF THE INVENTION

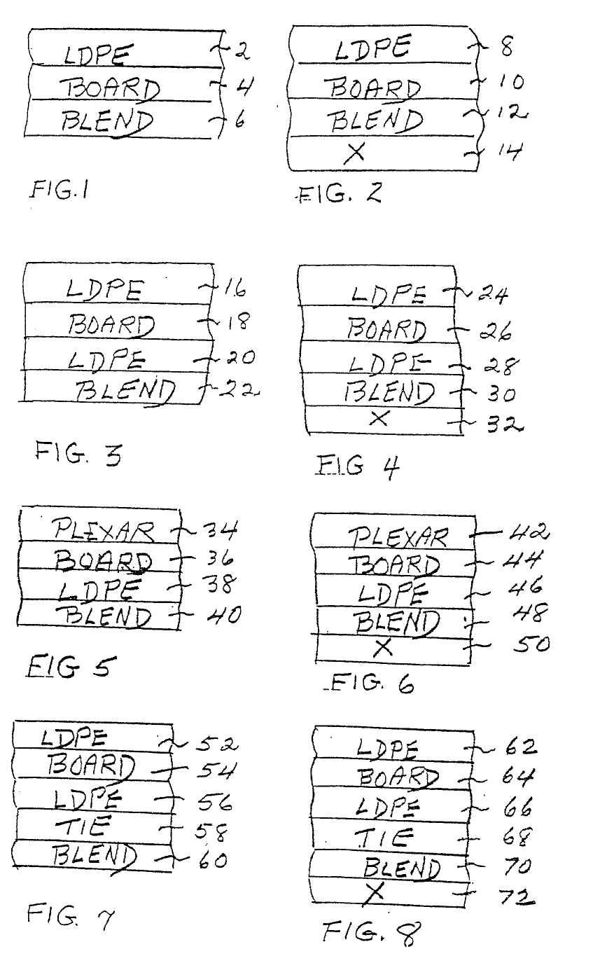

Referring to FIG. 1 the laminate of the present invention is shown as comprising a paperboard substrate 4 which is most suitably high-grade paperboard stock such as 0.010 to 0.028 milk carton stock for example, 282 lb. Milk Carton Board to which is applied on the exterior portion of the laminate, a coating of low density polyethylene (“LDPE”) 2 in a coating weight preferably ranging from about 5 to about 20 pounds per ream. Any commercial extrusion coating grade LDPE is suitable for use herein for example Gulf 4517 polyethylene available from Gulf Oil Chemicals Company, Houston, Tex. On the back or interior portion of the board there is a applied a polymeric nanocomposite oxygen barrier layer 6 formed from a polymeric blend comprising one or more resins having a layered silicate dispersed therein.

Referring now to FIG. 3 depicting an alternate embodiment of the laminate of the present invention. In this alternate embodiment, the paperboard substrate 18 is coated on the external surface thereof with a layer of heat sealable LDPE 16. On the internal surface of the paperboard substrate there is applied a layer of LDPE 20. Overlying the LDPE layer 20 is a layer of the polymeric nanocomposite blend 22.

FIG. 5 discloses an embodiment of the laminate of the invention which has as the exterior layer applied on the paperboard 36 a layer of Plexar 34. On the back or interior portion of the paperboard 36, there is applied a layer of LDPE 38. Overlaying the LDPE layer is a layer of the polymeric nanocomposite blend 40. The modified polyolefin, or more correctly, the outer polyolefin layer modified to be compatible with and heat sealable to the inner product-contact barrier material is preferably selected from a group of materials identified by the trademark PLEXAR, and more particularly, PLEXAR 177 or PLEXAR 175. The PLEXARS 175 and 177 are modified, low density polyethylene-based adhesives which provide strong bonds to ethylene vinyl alcohol copolymers (EVOH), high and low density polyethylenes, ethylene copolymers, paper and paperboard. They are suitable for both coextrusion coating and cast film coextrusion. The tie layers used in the alternative embodiment of the present invention would also preferably be PLEXARS. The PLEXAR class of adhesives are available from USI Corporation and are fully described in U.S. Pat. Nos. 4,087,587 and 4,087,588.

FIG. 7 discloses another embodiment of the present invention which makes use of a paperboard substrate 54 sandwiched between two layers of low density polyethylene 52, 56. Overlying the LDPE layer 56 is a tie layer 58 such as Plexar 177 or a coextruded sandwich of plexar 177, EVOH and LDPE. A suitable extrusion coatable adhesive may be substituted for the tie layer such as DuPont's cXa's or Shell's Kratons or copolymers of ethylene and methacrylic acid. On the interior portion of the laminate, namely onto the tie layer there is applied a layer of the polymeric nanocomposite blend 60.

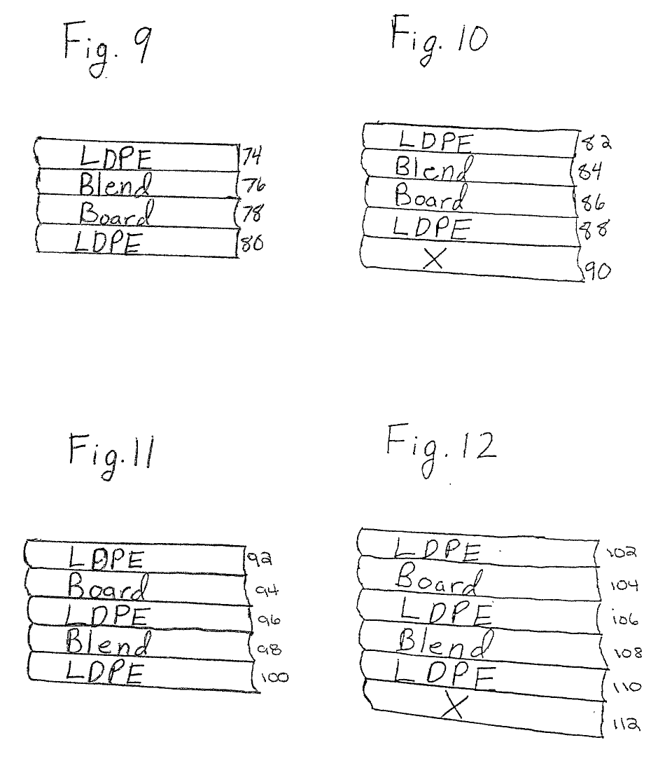

FIGS. 2, 4, 6 and 8 correspond to FIGS. 1, 3, 5 and 7 respectively except that an additional “skin” layer X (14 in FIG. 2, 32 in FIG. 4, 50 in FIG. 6 and 72 in FIG. 8) is utilized in addition to the layers disclosed in FIGS. 1, 3, 5 and 7 as the interior layer for adding greater barrier resistance to the passage of oxygen and resultant loss of Vitamin C and which enhances flavor retention. This innermost layer X can be any of EVOH, polyethylene isophthalate, polyethylene terephthalate, acid or glyco-modified copolymers polyethylene terephthalate and polyethlene isophthalate, polyamides, polycaprolactams and polycarbonates.

The polymeric nanocomposites oxygen barrier layer is a polymeric blend comprising one or more resins having a layered silicate dispersed therein. The silicate preferably has a layer thickness of about 7 to 12 A and a interlayer distance preferably of about 20 A or above, and most preferably 30 A or above. A number of useful resins will be apparent to those skilled in the art in light of the disclosure herein including polymers such as aromatic aliphatic and aromatic/aliphatic polyamides and copolyamides such as Nylon 6, Nylon 12, Nylon 6,6, poly [bis(4-amino cyclohex1) methane 1,10-decanedicanarbonamide]; amorphous polyamides and copolyamides; polyesters and copolyesters such as PET, poly (1.4-cyclohexane dimethylene terephthalate), and poly (butyleneterephthalate) and poly (ethylene napthalate); and polymers and copolymers formed from polymerization of α, β-unsaturated monomers such as polyethylene, EVOH and the like. A single resin or blend or two or more resins may be used. Examples of amorphous polyamides are disclosed in U.S. Pat. No. 5,286,575.

The content of the layered silicate in the resin should preferably be 0.05 to 150 parts by weight for 100 parts by weight of the resin. A polymeric nanocomposite material employed by the present invention may be produced according to the process explained in U.S. Pat. Nos. 4,889,885 and 4,739,007.

The laminates of the present invention can be easily fabricated. For example the layers can be directly extruded onto the paperboard substrate or other layer as disclosed above. In the case of the use of the tie layer for facilitating adhesion, the LDPE and the tie layer can be directly coextruded on to the paperboard substrate or the various layers of the multiple layer structures may be held together by any of a variety of adhesive resins. In general, such adhesive resins are polymers having carbonyl groups derived from functional groups of free carboxylic acids, carboxylic acid salts, carboxylic acid esters, carboxylic acid amides, carboxylic anhydrides, carbonic acid esters, urethanes, ureas or the like. Suitable adhesive resins include polyolefins modified with at least on ethylenically unsaturated monomer selected from unsaturated carboxylic acids and anhydrides, esters and amides thereof especially polypropylene, high density polyethylene, low density polyethylene and ethylene-vinyl acetate copolymers modified with at least one member selected from acrylic acid, methacrylic acid, crotonic acid, fumaric acid, itaconic acid, maleic anhydride, itaconic anhydride, citraconic anhydride, ethyl acrylate, methyl methacrylate, ethyl maleate, 2-ethyethexyl acrylate, acrylamide, methacrylamide, fatty acid amides, and imides of the acids described above. The adhesive can also be prepared from an ethylene polymer and a second polymer grafted with maleic anhydride, as disclosed in U.S. Pat. No. 4,230,830, the disclosure of which is incorporated herein by reference. In addition, as the adhesive resin, there can be used ethylene-acrylate copolymers, ionomers, polyalkylene oxide-polyester block copolymers, carboxy-methyl cellulose derivatives, and blends of these polymers with polyolefins.

Both the use of flame treatment and corona discharge or the like can be used where it is desired to enhance adhesion. It should be apparent to those skilled in the art that any conventional techniques for applying the overlying layers to the paperboard substrate and to each other can be suitably employed.

The effectiveness of the laminates of the present invention is in part due to their functioning as a barrier to migration of essential oils and flavors, their increased barrier resistance to oxygen so that Vitamin C is not lost and their acting as a barrier to other gases such as carbon dioxide and various aromas. The laminates of the invention not only have the advantages of the improved barrier properties which extend the shelf life of the juice but that the laminates can be produced using conventional blending and extrusion equipment.

The foregoing description and figures have been presented for purposes of illustration and description. It is not intended to be exhaustive or to limit the invention to the precise forms disclosed. Obvious modifications or variations will be apparent in light of the above teachings.

What is claimed is:

1. A container for liquids containing essential oils, flavors and Vitamin C, said container constructed from a laminate comprising:
(a) a paperboard substrate;
(b) an outer layer of a member selected from the group consisting of heat-sealable low density polyethylene polymers and Plexar, said outer layer coated on the outer surface of said paperboard substrate; and
(c) an inner oxygen barrier layer of a polymeric nanocomposite blend comprising at least one resin and a layered silicate dispersed in said resin.

2. The container of claim 1 wherein said laminate has a layer of low density polyethylene polymer coated on said inner surface of said paperboard substrate.

3. The container of claim 2 wherein said laminate has an inner tie layer coated on said inner surface of said inner layer of low density polyethylene.

4. The container of claim 3 wherein said tie layer is a member selected from the group consisting of Plexar, copolymers of ethylene and methacrylic acid, modified polyolefin, modified copolymer of an olefin, and ethylene vinyl acetate.

5. The container of claim 1 wherein said laminate further comprises a skin layer applied to the surface of said blend in contact with said liquid.

6. The container of claim 5 wherein said skin layer is a member selected from the group consisting of ethylene vinyl alcohol copolymer (EVOH), polyethyleneterephthalate, polyethyleneisophthalate, acid or glycol-modified copolymers of polyethylene-terephthalate, polyethylene isophthalate polyamides, polycaprolactams and polycarbonates.

7. The container of claim 1 wherein said outermost layer of said laminate is a heat sealable low density polyethylene polymer.

8. The container of claim 1 wherein said silicate has a layer thickness of about 7 to 12 A and an interlayer thickness of about 30 A or greater.

9. The container of claim 1 wherein said at least one resin is a polymer selected from the group consisting of aromatic polyamides, aliphatic polyamides, aromatic/aliphatic polyamides, amorphous polyamides, aromatic copolyamides, aliphatic copolyamides, aromatic/aliphatic copolyamides, amorphous copolyamides, polyesters, copolyesters, polymers formed from the polymerization of α, β-unsaturated monomers, and copolymers formed from the polymerization of α, β-unsaturated monomers.

10. The container of claim 9 wherein said polymeric nanocomposite blend comprises at least two resins.

11. A multiple layer structure comprising:
(a) a paperboard substrate;
(b) an outer layer of a member selected from the group consisting of a heat sealable low density polyethylene and Plexar coated on the outer surface of said paperboard substrate; and
(c) an inner barrier layer of a polymeric nanocomposite blend comprising at least one resin and a layered silicate dispersed in said resin.

12. The multiple layer structure of claim 11 wherein an inner layer of LDPE is interposed between said paperboard substrate and said inner layer of the blend of EVOH and polyamide.

13. The multiple layer structure of claim 12 wherein a tie layer is coated onto said inner layer of LDPE and said layer of the blend of EVOH and polyamide.

14. The multiple layer structure of claim 13 wherein said tie layer is a member selected from the group consisting of Plexar, copolymers of ethylene and methacrylic acid, modified polyolefin, modified copolymer of an olefin, and ethylene vinyl acetate.

15. The multiple layer structure of claim 13 wherein a skin layer is applied onto the outermost surface of said blend.

16. The multiple layer structure of claim 15 wherein said skin layer is a member selected from the group consisting of ethylene vinyl alcohol copolymer (EVOH), polyethyleneterephthalate, polyethylene-isophthalate, acid or glycol-modified copolymers of polyethyleneterephthalate, polyethyleneisophthalate, polyamides, polycaprolactams and polycarbonates.

17. The multiple layer structure of claim 11 wherein said outer layer is low density polyethylene.

18. The multiple layer structure of claim 11 wherein said silicate has a layer thickness of about 7 to 12 A and an interlayer thickness of about 30 A or greater.

19. The container of claim 11 wherein said at least one resin is a polymer selected from the group consisting of aromatic polyamides, aliphatic polyamides, aromatic/aliphatic polyamides, amorphous polyamides, aromatic copolyamides, aliphatic copolyamides, aromatic/aliphatic copolyamides, amorphous copolyamides, polyesters, copolyesters, polymers formed from the polymerization of α, β-unsaturated monomers, and copolymers formed from the polymerization of α, β-unsaturated monomers.

20. The container of claim 19 wherein said polymeric nanocomposite blend comprises at least two resins.
